(19) United States
(12) Patent Application Publication
(10) Pub. No.: US 2019/0285973 A1
(43) Pub. Date: Sep. 19, 2019

(54) WAVELENGTH CONVERSION ELEMENT, LIGHT SOURCE DEVICE, AND PROJECTOR

(71) Applicant: SEIKO EPSON CORPORATION, Tokyo (JP)

(72) Inventor: Toshiaki HASHIZUME, Okaya-shi (JP)

(73) Assignee: SEIKO EPSON CORPORATION, Tokyo (JP)

(21) Appl. No.: 16/356,236

(22) Filed: Mar. 18, 2019

(30) Foreign Application Priority Data
Mar. 19, 2018 (JP) 2018-051616

(51) Int. Cl. G03B 21/20; C09K 11/77; C09K 11/02

(52) U.S. Cl. CPC G03B 21/204; C09K 11/02; C09K 11/7774

(57) ABSTRACT

A wavelength conversion element according to the invention includes a wavelength conversion layer including a plurality of phosphor particles made of an yttrium aluminum garnet (YAG) type phosphor material including cerium (Ce) as a activator agent, and a binder made of glass adapted to hold the plurality of phosphor particles, and the refractive index of the binder is higher than the refractive index of the phosphor particles.

### BACKGROUND

### 1. Technical Field

The present invention relates to a wavelength conversion element, a light source device and a projector.

### 2. Related Art

As a light source device used for a projector, there is proposed a light source device using fluorescence emitted from a phosphor when irradiating the phosphor with excitation light emitted from a light emitting element such as a semiconductor laser.

In JP-A-2016-191959 (Document 1), there is disclosed a wavelength conversion member provided with a wavelength conversion member main body including inorganic phosphor powder and a glass matrix, and a low-refractive index layer. In Document 1, there are described the fact that it is preferable for the glass matrix to have a refractive index in a range of 1.45 through 2.00, and the fact that the refractive index of the inorganic phosphor powder is higher than the refractive index of the glass matrix and the glass constituting the glass layer as much as 0.05 or more, and further as much as 0.1 or more in order to obtain the wavelength conversion member capable of emitting high intensity fluorescence.

In International Patent Publication No. WO 2013/172025 (Document 2), there is disclosed a wavelength conversion element provided with a plurality of phosphor particles and a zinc oxide matrix. In Document 2, there is described the fact that by using the zinc oxide matrix which is an inorganic matrix having a high refractive index, and high in heat resistance and ultraviolet light resistance, light scattering in the phosphor layer decreases, and it is possible to realize an LED element, a semiconductor laser emitting device and a phosphor layer high in optical output. Further, there is also described the fact that the refractive index of the phosphor used typically for an LED is in a range of 1.8 through 2.0.

In the wavelength conversion elements described in Document 1 and Document 2, since the refractive index of the matrix is low, there occurs a phenomenon that a part of the light generated in the phosphor particles cannot get out from the inside of the phosphor particles but is confined inside the phosphor particles. The energy of the light thus confined is absorbed again in the light emitting section of the phosphor particles to turn to heat. Therefore, there is a problem that the phosphor particles are excited by excitation light, the electron level is partially changed in a process of discharging the energy to decrease the emission efficiency. Therefore, in the case in which the refractive index of the matrix is low, due to the reason described above, there is a problem that the fluorescent is reabsorbed by the phosphor particles, and thus the wavelength conversion efficiency lowers.

### SUMMARY

An advantage of some aspects of the invention is to provide a wavelength conversion element capable of suppressing deterioration of the wavelength conversion efficiency to solve the problem. Another advantage of some aspects of the invention is to provide a light source device equipped with the wavelength conversion element described above. Still another advantage of some aspects of the invention is to provide a projector equipped with the light source device described above.

A wavelength conversion element according to an aspect of the invention includes a wavelength conversion layer including a plurality of phosphor particles made of an yttrium aluminum garnet (YAG) type phosphor material including cerium (Ce) as a activator agent, and a binder made of glass adapted to hold the plurality of phosphor particles, and a refractive index of the binder is higher than a refractive index of the phosphor particles.

In the wavelength conversion element according to the aspect of the invention, a difference between the refractive index of the binder and the refractive index of the phosphor particles is 0.1 or more.

A light source device according to another aspect of the invention includes an excitation light source adapted to emit excitation light, and the wavelength conversion element according to the aspect of the invention.

A projector according to another aspect of the invention includes the light source device according to the aspect of the invention, a light modulation device adapted to modulate light from the light source device in accordance with image information to thereby form image light, and a projection optical device adapted to project the image light.

### BRIEF DESCRIPTION OF THE DRAWINGS

The invention will be described with reference to the accompanying drawings, wherein like numbers reference like elements.

FIG. 1 is a schematic configuration diagram of a projector according to an embodiment of the invention.

FIG. 2 is a perspective view of a wavelength conversion element according to the present embodiment.

FIG. 3 is a cross-sectional view of the wavelength conversion element.

FIG. 4 is a cross-sectional view of a related-art wavelength conversion element.

FIG. 5 is a graph showing a relationship between excitation light density and emission efficiency in the related-art wavelength conversion element.

FIG. 6 is a graph showing a relationship between excitation light density and emission efficiency in the wavelength conversion element according to the embodiment.

### DESCRIPTION OF AN EXEMPLARY EMBODIMENT

Hereinafter, an embodiment of the invention will be described with reference to the drawings.

In the following drawings, the constituents are shown with the respective scale ratios of the sizes different from each other in some cases in order to make the constituents eye-friendly.

An example of a projector according to the present embodiment will be described.

The projector according to the present embodiment is a projection-type image display device for displaying a color image on a screen (a projection target surface). The projector is provided with three liquid crystal light modulation devices corresponding respectively to colored light, namely red light, green light, and blue light. The projector is provided with semiconductor lasers capable of obtaining high-intensity and high-power light as light sources of an illumination device.

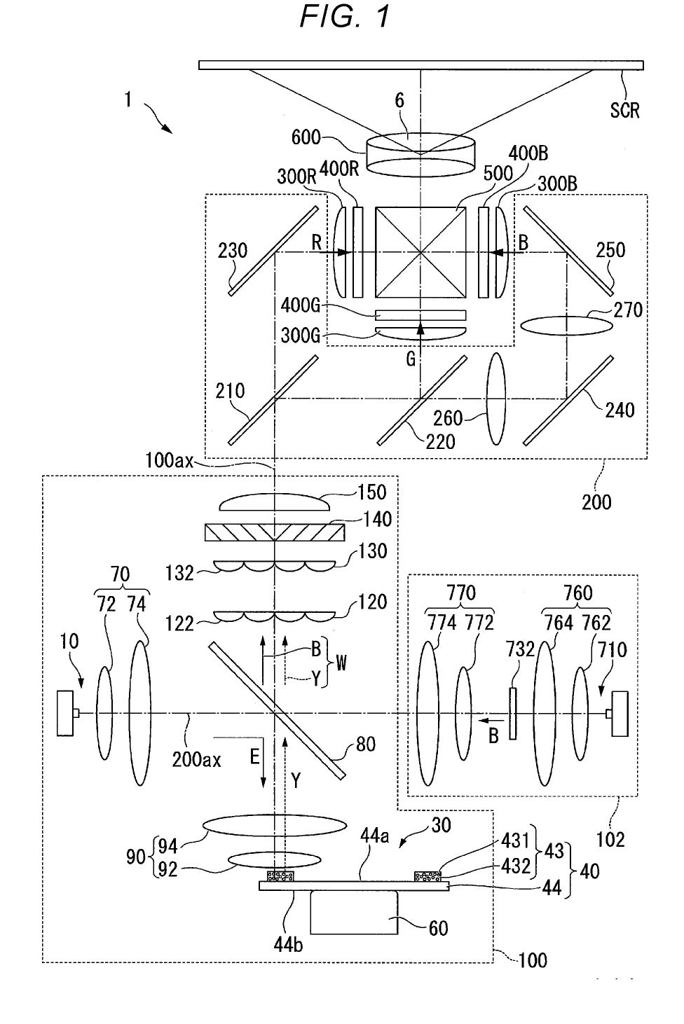

FIG. 1 is a schematic configuration diagram showing an optical system of the projector according to the present embodiment.

As shown in FIG. 1, a projector 1 is provided with a first light source device 100, a second light source device 102, a color separation light guide optical system 200, a liquid crystal light modulation device 400R, a liquid crystal light modulation device 400G, a liquid crystal light modulation device 400B, a cross dichroic prism 500, and a projection optical device 600.

The first light source device 100 according to the present embodiment corresponds to a light source device in the appended claims.

The first light source device 100 is provided with a first light source 10, a collimating optical system 70, a dichroic mirror 80, a collimating light collection optical system 90, a wavelength conversion device 30, a first lens array 120, a second lens array 130, a polarization conversion element 140, and a superimposing lens 150.

The first light source 10 according to the present embodiment corresponds to an excitation light source in the appended claims.

The first light source 10 is formed of a semiconductor laser for emitting blue excitation light E having the peak of the emission intensity at the wavelength of, for example, 445 nm. It is possible for the first light source 10 to be formed of a single semiconductor laser, or to be formed of a plurality of semiconductor lasers. As the first light source 10, it is also possible to use a semiconductor laser for emitting the blue excitation light having the peak of the emission intensity at other wavelengths than the wavelength of 445 nm such as a wavelength of 460 nm. The first light source 10 is disposed so that the light axis 200ax of the excitation light E emitted from the first light source 10 is perpendicular to an illumination light axis 100ax.

The collimating optical system 70 is provided with a first lens 72 and a second lens 74. The collimating optical system 70 roughly collimates the light emitted from the first light source 10. The first lens 72 and the second lens 74 are each formed of a convex lens.

The dichroic mirror 80 is disposed in a light path from the collimating optical system 70 to the collimating light collection optical system 90 so as to cross each of the light axis 200ax and the illumination light axis 100ax at an angle of 45°. The dichroic mirror 80 reflects the blue excitation light E emitted from the first light source 10, while transmitting yellow fluorescence Y emitted from the wavelength conversion device 30 described later.

The collimating light collection optical system 90 has a function of converging the excitation light E reflected by the dichroic mirror 80 to enter a wavelength conversion element 40 described later, and a function of roughly collimating the fluorescence Y emitted from the wavelength conversion element 40 to enter the dichroic mirror 80. The collimating light collection optical system 90 is provided with a first lens 92 and a second lens 94. The first lens 92 and the second lens 94 are each formed of a convex lens.

The second light source device 102 is provided with a second light source device 710, a light collection optical system 760, a diffusion plate 732, and a collimating optical system 770.

The second light source 710 is formed of the same semiconductor laser as that of the first light source 10. Alternatively, in the case in which the first light source 10 is formed of the semiconductor laser for emitting the light having the emission peak at the wavelength of 445 nm, it is also possible for the second light source 710 to be formed of a semiconductor laser for emitting the light having the emission peak at the wavelength of 460 nm. It is possible for the second light source 710 to be formed of a single semiconductor laser, or to be formed of a plurality of semiconductor lasers.

The light collection optical system 760 is provided with a first lens 762 and a second lens 764. The blue light B emitted from the second light source 710 is converged by the collection optical system 760 on the diffusion plate 732 or in the vicinity of the diffusion plate 732. The first lens 762 and the second lens 764 are each formed of a convex lens.

The diffusion plate 732 diffuses the blue light B from the second light source 710 to thereby generate the blue light B having a light distribution similar to the light distribution of the fluorescence Y having been emitted from the wavelength conversion device 30. As the diffusion plate 732, there can be used, for example, obscured glass made of optical glass.

The collimating optical system 770 is provided with a first lens 772 and a second lens 774. The collimating optical system 770 roughly collimates diffusion light emitted from the diffusion plate 732. The first lens 772 and the second lens 774 are each formed of a convex lens.

The blue light B having been emitted from the second light source device 102 is reflected by the dichroic mirror 80, then combined with the fluorescence Y having been transmitted through the dichroic mirror 80 to turn to white light W. The white light W enters the first lens array 120.

The first lens array 120 has a plurality of first lenses 122 for dividing the light from the dichroic mirror 80 into a plurality of partial light beams . The plurality of first lenses 122 are arranged in a matrix in a plane perpendicular to the illumination light axis 100ax.

The second lens array 130 has a plurality of second lenses 132 corresponding respectively to the plurality of first lenses 122 of the first lens array 120. The second lens array 130 forms the image of each of the first lenses 122 of the first lens array 120 in the vicinity of the image forming area of each of the liquid crystal light modulation device 400R, the liquid crystal light modulation device 400G, and the liquid crystal light modulation device 400B in cooperation with the superimposing lens 150 in the posterior stage. The plurality of second lenses 132 are arranged in a matrix in a plane perpendicular to the illumination light axis 100ax.

The partial light beams divided into by the first lens array 120 are converted by the polarization conversion element 140 into linearly-polarized light beams aligned in the polarization direction with each other. Although not shown in the drawing, the polarization conversion element 140 is provided with a polarization separation layer, a reflecting layer and a retardation layer.

The superimposing lens 150 converges each of the partial light beams emitted from the polarization conversion element 140 to superimpose the partial light beams on each other in the vicinity of the image forming area of each of the liquid crystal light modulation device 400R, the liquid crystal light modulation device 400G, and the liquid crystal light modulation device 400B. The first lens array 120, the second lens array 130 and the superimposing lens 150 constitute an integrator optical system for homogenizing the in-plane light intensity distribution of the light from the wavelength conversion device 30.

The color separation light guide optical system 200 is provided with a dichroic mirror 210, a dichroic mirror 220, a reflecting mirror 230, a reflecting mirror 240, a reflecting mirror 250, a relay lens 260, and a relay lens 270. The color separation light guide optical system 200 separates the white light W obtained from the first light source device 100 and the second light source device 102 into the red light R, the green light G and the blue light B, and then guides the red light R, the green light G and the blue light B to the liquid crystal light modulation device 400R, the liquid crystal light modulation device 400G and the liquid crystal light modulation device 400B corresponding respectively to the red light R, the green light G and the blue light B.

A field lens 300R is disposed between the color separation light guide optical system 200 and the liquid crystal light modulation device 400R. A field lens 300G is disposed between the color separation light guide optical system 200 and the liquid crystal light modulation device 400G. A field lens 300B is disposed between the color separation light guide optical system 200 and the liquid crystal light modulation device 400B.

The dichroic mirror 210 is a dichroic mirror for transmitting a red light component and reflecting a green light component and a blue light component. The dichroic mirror 220 is a dichroic mirror for reflecting the green light component and transmitting the blue light component. The reflecting mirror 230 is a reflecting mirror for reflecting the red light component. The reflecting mirror 240 and the reflecting mirror 250 are each a mirror for reflecting the blue light component.

The red light R having been transmitted through the dichroic mirror 210 is reflected by the reflecting mirror 230, then transmitted through the field lens 300R, and then enters the image forming area of the liquid crystal light modulation device 400R. The green light G having been reflected by the dichroic mirror 210 is further reflected by the dichroic mirror 220, then transmitted through the field lens 300G, and then enters the image forming area of the liquid crystal light modulation device 400G. The blue light B having been transmitted through the dichroic mirror 220 enters the image forming area of the liquid crystal light modulation device 400B via the relay lens 260, the reflecting mirror 240 on the incident side, the relay lens 270, the reflecting mirror 250 on the exit side, and the field lens 300B.

The liquid crystal light modulation device 400R, the liquid crystal light modulation device 400G, and the liquid crystal light modulation device 400B each modulate the colored light having entered the liquid crystal light modulation device in accordance with the image information to thereby form a color image corresponding to the colored light. Although not shown in the drawing, on the light incident side of each of the liquid crystal light modulation device 400R, the liquid crystal light modulation device 400G and the liquid crystal light modulation device 400B, there is disposed an incident side polarization plate. On the light exit side of each of the liquid crystal light modulation device 400R, the liquid crystal light modulation device 400G and the liquid crystal light modulation device 400B, there is disposed an exit side polarization plate.

The cross dichroic prism 500 combines the image light emitted from the liquid crystal light modulation device 400R, the image light emitted from the liquid crystal light modulation device 400G, and the image light emitted from the liquid crystal light modulation device 400B with each other to form a color image. The cross dichroic prism 500 has a configuration having four rectangular prisms bonded to each other, and on the substantially X-shaped interfaces on which the rectangular prisms are bonded to each other, there are formed dielectric multilayer films.

The color image emitted from the cross dichroic prism 500 is projected in an enlarged manner by the projection optical device 600 to form an image on the screen SCR. The projection optical device 600 is formed of a plurality of projection lenses 6.

Hereinafter, the wavelength conversion device 30 will be described in detail.

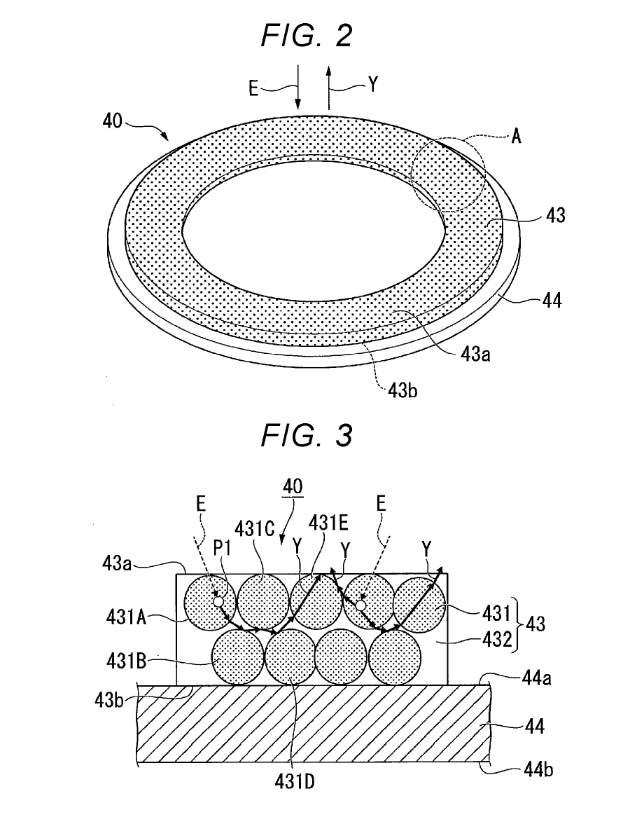

FIG. 2 is a perspective view of the wavelength conversion element 40.

As shown in FIG. 1 and FIG. 2, the wavelength conversion device 30 is provided with the wavelength conversion element 40 and a motor 60. The wavelength conversion element 40 is provided with a wavelength conversion layer 43 and a substrate 44. The wavelength conversion element 40 emits the fluorescence Y toward the same side as the side which the excitation light E enters. The substrate 44 functions as a reflecting plate for reflecting the fluorescence Y having been emitted from the wavelength conversion layer 43 toward the substrate 44. In other words, the wavelength conversion element 40 according to the present embodiment is a reflective-type wavelength conversion element. It should be noted that it is also possible for the wavelength conversion element 40 to be provided with a bonding layer (not shown) for bonding the wavelength conversion layer 43 and the substrate 44 to each other. It is also possible for the bonding layer to have a light transmissive property. As shown in FIG. 2, the wavelength conversion layer 43 is formed to have an annular shape. The thickness of the wavelength conversion layer 43 is, for example, 40 through 200 μm.

FIG. 3 is a cross-sectional view of the wavelength conversion element 40 showing the part denoted by the reference symbol A in FIG. 2 in an enlarged manner.

As shown in FIG. 3, the wavelength conversion layer 43 is formed of a phosphor layer which is excited by the excitation light E emitted from the first light source 10 to emit the fluorescence Y as yellow light. The wavelength conversion layer 43 is provided with a plurality of phosphor particles 431 and a binder 432 for holding the plurality of phosphor particles 431.

The phosphor particles 431 are each formed of an yttrium aluminum garnet (YAG) type phosphor material constituted by (Y, Gd)₃ (Al, Ga)₅O₁₂ (YAG:Ce) including cerium (Ce) as an activator agent. The binder 432 is formed of glass. Hereinafter, out of the surfaces of the wavelength conversion layer 43, a surface which the excitation light E enters is referred to as a first surface 43a, and a surface on the opposite side to the first surface 43a is referred to as a second surface 43b.

As an example, the phosphor particles 431 each have a configuration in which the Ce ions are added as the activator agent in YAG in a concentration no lower than 0.2 mol % and no higher than 1.2 mol % . The wavelength conversion layer 43 has a configuration in which the phosphor particles 431 are included in the binder 432 in a volume percent concentration no lower than 50%. As an example, the binder 432 is formed of LAM type glass consisting primarily of lanthanum oxide.

The refractive index of the binder 432 is higher than the refractive index of the phosphor particles 431. The refractive index of the phosphor particles 431 is, for example, about 1.83. The refractive index of the binder 432 is, for example, about 1.93 through 2.00. Therefore, the refractive index of the binder 432 is higher than the refractive index of the phosphor particles 431 as much as 0.1 or more.

The substrate 44 is disposed on the second surface 43b of the wavelength conversion layer 43. For the substrate 44, there is used a disc-like member made of a material high in thermal conductivity such as aluminum or copper. Thus, it is possible for the substrate 44 to ensure a high radiation performance. As described above, the substrate 44 functions as a reflecting plate for reflecting the fluorescence Y having proceeded from the wavelength conversion layer 43 toward the substrate 44. It should be noted that it is also possible for a reflecting layer made of aluminum or the like high in reflectivity to be disposed on the second surface 43b of the wavelength conversion layer 43 or a first surface 44a of the substrate 44.

In the case in which the bonding layer is used, the bonding layer intervenes between the first surface 44a of the substrate 44 and the second surface 43b of the wavelength conversion layer 43 to bond the substrate 44 and the wavelength conversion layer 43 to each other. As the bonding layer, there is used a high thermal conductivity adhesive obtained by, for example, mixing fine particles high in thermal conductivity into resin. Thus, it is possible for the bonding layer to efficiently transfer the heat of the wavelength conversion layer 43 to the substrate 44.

The motor 60 (see FIG. 1) rotates the wavelength conversion element 40 around a rotational axis perpendicular to the first surface 44a of the substrate 44 and a second surface 44b on an opposite side to the first surface 44a. In the present embodiment, by rotating the wavelength conversion element 40, the incident position of the excitation light E on the wavelength conversion layer 43 is changed temporally. Thus, the wavelength conversion layer 43 is always irradiated with the excitation light E at the same part of the wavelength conversion layer 43, and thus, the deterioration of the wavelength conversion layer 43 caused by locally heating the wavelength conversion layer 43 can be suppressed.

Problems of the related-art wavelength conversion element, functions and advantages of the wavelength conversion element 40 according to the present embodiment will hereinafter be described.

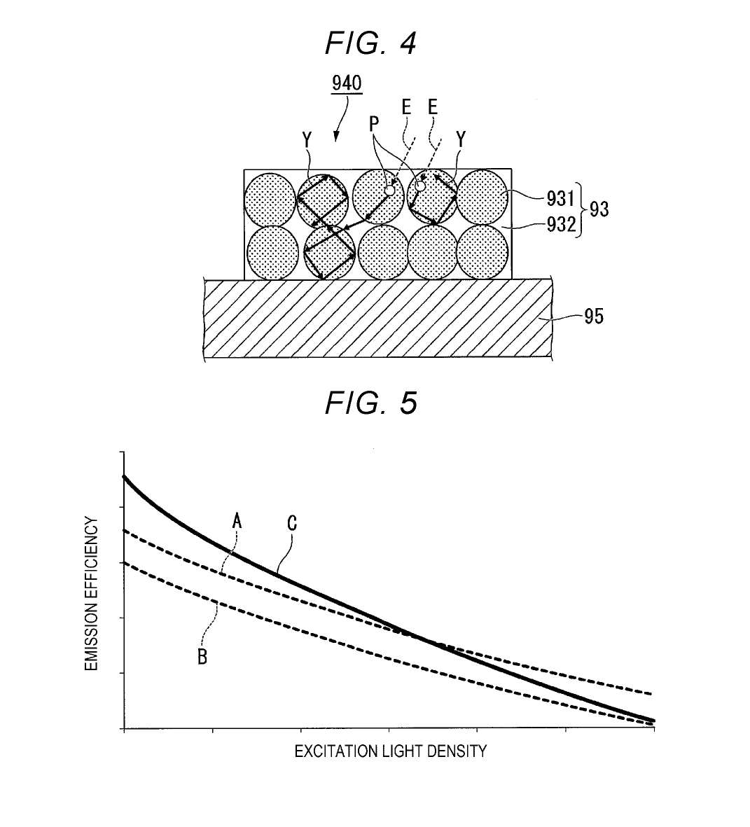

FIG. 4 is a cross-sectional view of a wavelength conversion element 940 of the related-art.

As shown in FIG. 4, the related-art wavelength conversion element 940 is provided with a wavelength conversion layer 93 including a plurality of phosphor particles 931 and a binder 932, and a substrate 95. In the wavelength conversion layer 93 of the related art, the refractive index of the phosphor particles 931 made of YAG:Ce is 1.83, and the refractive index of the binder 932 made of glass is 1.5. As described above, the refractive index of the binder 932 is lower than the refractive index of the phosphor particles 931.

When the excitation light E is applied to a light emitting section P made of the Ce activator agent inside the phosphor particle 931, the electrons of the light emitting section P are excited, and the fluorescence Y is emitted in all directions. It should be noted that in FIG. 4, a beam of the fluorescence Y emitted from each of the light emitting sections P alone is illustrated. In the case of assuming, for example, the refractive index of the phosphor particles 931 as 1.83, and the refractive index of the binder 932 as 1.5, the fluorescence Y entering the interface between the phosphor particle 931 and the binder 932 at the incident angle no smaller than 55° is totally reflected by the interface, and is therefore not emitted outside the phosphor particle 931, but is confined inside the phosphor particle 931. An amount of the fluorescence Y confined inside the phosphor particle 931 corresponds to 30% of the total amount of the emitted light in the case of assuming that the light emitting sections P are uniformly distributed inside the phosphor particle 931.

Most of the fluorescence Y confined inside the phosphor particle 931 is reabsorbed by the light emitting section P, and is converted into heat. On this occasion, by partially changing the electron level in the process in which the phosphor particle 931 discharges the energy, the emission efficiency deteriorates. In the case of increasing in particular the amount of the excitation light E, an amount of heat generation increases, and the emission efficiency deteriorates. It should be noted that the emission efficiency is a proportion of the amount of the light taken from the phosphor particle to the amount of the excitation light.

Further, in the case in which the excitation light E having entered the phosphor particle 931 fails to be applied to the light emitting section P, the excitation light E is reflected by the interface between the phosphor particle 931 and the binder 932, and is then applied to another light emitting section P inside the phosphor particle 931 in some cases.

As described above, by increasing the light density of the fluorescence Y and the light density of the excitation light E inside the phosphor particle 931, the amount of heat generation in the phosphor particle 931 increases, and thus, the emission efficiency deteriorates. As a result, the wavelength conversion efficiency of the wavelength conversion element 940 deteriorates.

In particular, in the case of the wavelength conversion element used for the light source device for the projector, in order to obtain a higher output (a larger amount of light emitted), it is necessary to obtain a high-intensity light output from a small irradiation area with the excitation light. Therefore, it is performed that the size of the irradiation area with the excitation light is decreased, the concentration of the phosphor particles is increased to a level no lower than 50 volume %, irradiation is performed with high energy excitation light to thereby obtain a large amount of light. Therefore, the problem that if the refractive index of the binder is low, the fluorescence is reabsorbed by the phosphor particles to lower the emission efficiency, and thus, the wavelength conversion efficiency deteriorates on the grounds described above has become conspicuous.

Therefore, the inventors have investigated by experiments a relationship between the excitation light density and the emission efficiency in the case of varying the activator agent concentration (the Ce concentration) and the concentration (the volume concentration to the whole of the wavelength conversion layer) of the phosphor particles in the related-art wavelength conversion element.

FIG. 5 is a graph showing the relationship between the excitation light density and the emission efficiency in the related-art wavelength conversion element. In FIG. 5, the horizontal axis represents the excitation light density (a relative value), and the vertical axis represents the emission efficiency (a relative value). The graph denoted by the reference symbol A represents data corresponding to the case in which the Ce concentration is no higher than 0.5% and the phosphor particle concentration is 70%. The graph denoted by the reference symbol B represents data corresponding to the case in which the Ce concentration is no higher than 0.5% and the phosphor particle concentration is no higher than 50%. The graph denoted by the reference symbol C represents data corresponding to the case in which the Ce concentration is higher than 1% and the phosphor particle concentration is no lower than 50%. The phosphor particles are each formed of YAG:Ce, and the refractive index of the glass binder is 1.5 in any data.

As shown in FIG. 5, according to the configuration of the related art, the deterioration of the emission efficiency due to the increase in the excitation light density is significant in the area where the excitation light density is low, and although the gradient of the decrease in the emission efficiency becomes slightly gentle in the area where the excitation light density is high, the emission efficiency deteriorates after all. It should be noted that assuming that the shape of the phosphor particle is spherical, the maximum value of the phosphor particle concentration is theoretically about 74 volume %. As is obvious from the graph A and the graph B, if the phosphor particle concentration lowers, the emission efficiency also significantly deteriorates, and therefore, the phosphor particle concentration is at least requested to be no lower than 50 volume %. Further, as is obvious from the graph C, as the Ce concentration rises, the gradient of the decrease in the emission efficiency due to the increase in the excitation light density becomes steeper. It is conceivable that the reason therefor is that the reabsorption of the fluorescence inside the phosphor particles increases.

In contrast, as shown in FIG. 3, in the wavelength conversion element 40 according to the present embodiment, the refractive index of the binder 432 is higher than the refractive index of the phosphor particle 431. Therefore, most of the fluorescence Y generated at a light emitting point P1 of, for example, a phosphor particle 431A is transmitted through the interface between the phosphor particle 431A and the binder 432 to enter the binder 432. Subsequently, the fluorescence Y is sequentially reflected by the surfaces of the phosphor particle 431B, the phosphor particle 431C and the phosphor particle 431D, then proceeds while being confined inside the binder 432, and then enters a phosphor particle 431E. Then, the fluorescence Y proceeds inside the phosphor particle 431E, and is then emitted from the first surface 43a of the wavelength conversion layer 43.

As described above, since the refractive index of the binder 432 is high although the concentration of the phosphor particles 431 is as high as 50 volume % or more, the fluorescence Y proceeds while being confined mainly inside the binder 432, but is hardly confined inside the phosphor particles 431. Therefore, an amount of absorption of the fluorescence Y inside the phosphor particles 431 decreases compared to the related art, and thus, the heat generation due to the absorption also decreases. Further, the excitation light E hardly repeats reflection inside the phosphor particles 431. Therefore, according to the wavelength conversion element 40 related to the present embodiment, the deterioration of the emission efficiency can be suppressed, and it is possible to increase the amount of emission of the fluorescence Y even in the case of inputting the high-intensity excitation light E.

It should be noted that a difference in refractive index between the binder 432 and the phosphor particle 431 is desirably no lower than 0.1, and is more desirably no lower than 0.15. In the case in which the difference in refractive index between the binder 432 and the phosphor particle 431 is no higher than 0.1, an amount of total reflection in the interface between the binder 432 and the phosphor particle 431 is small, and the refracting angle in the interface is small. Therefore, the extraction effect of the light from the phosphor particle 431 is weak, and the light emitting area increases, and therefore, it is not preferable for the application to the projector.

Here, the inventors have investigated by experiments a relationship between the excitation light density and the emission efficiency in the wavelength conversion element 40 according to the present embodiment.

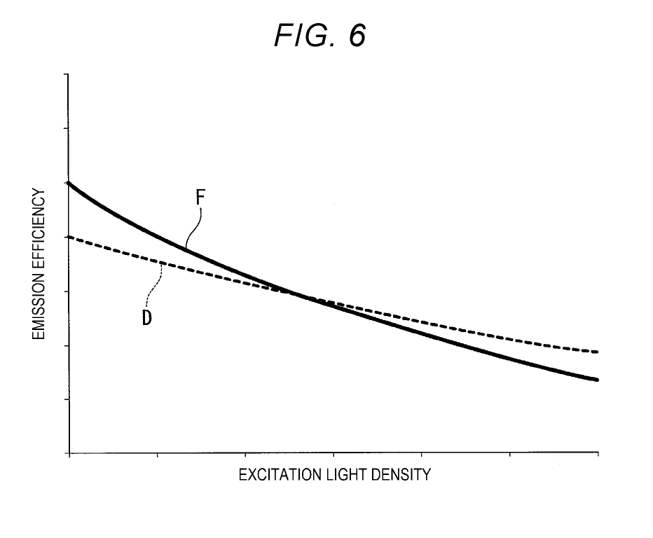

FIG. 6 is a graph showing the relationship between the excitation light density and the emission efficiency in the wavelength conversion element according to the present embodiment and the related-art wavelength conversion element. In FIG. 6, the horizontal axis represents the excitation light density (a relative value), and the vertical axis represents the emission efficiency (a relative value). The graph denoted by the reference symbol D represents data of the wavelength conversion element according to the present embodiment setting the refractive index of the binder to 1.99. The graph denoted by the reference symbol F represents data of the related-art wavelength conversion element setting the refractive index of the binder to 1.5. In both of the wavelength conversion element according to the present embodiment and the related-art wavelength conversion element, the Ce concentration is set to 1%, the phosphor particle concentration is set to 60 volume %.

As shown in the graph F of FIG. 6, in the related-art wavelength conversion element, the gradient of the decrease in the emission efficiency due to the increase in the excitation light density is steeper. In contrast, as shown in the graph D of FIG. 6, in the wavelength conversion element according to the present embodiment, the gradient of the decrease in the emission efficiency due to the increase in the excitation light density becomes gentler compared to the related-art wavelength conversion element. Thus, it has been found out that in the case of making the excitation light density equal to or higher than a predetermined value, the emission efficiency of the wavelength conversion element according to the present embodiment becomes higher than the emission efficiency of the related-art wavelength conversion element.

It should be noted that in Document 1, it is described that it is desirable for the refractive index of the glass binder to be in a range of 1.4 through 1.9. However, in the area of the refractive index of the glass binder from 1.83 to 1.9, the refractive index of the glass binder is higher than the refractive index of the phosphor particle, but has a small difference from the refractive index 1.83 of the phosphor particle. Therefore, even if the concentration of the phosphor particles is raised, the total reflection and the refracting angle in the interface between the phosphor particle and the glass binder cannot sufficiently be ensured for taking out the light from a small area, and therefore, the light is taken out from a large area of the wavelength conversion layer after all. As a result, there is a problem that the exit area of the light significantly spreads to deteriorate the efficiency of the optical system of the projector.

As described hereinabove, according to the wavelength conversion element 40 of the present embodiment, it is possible to suppress the deterioration of the wavelength conversion efficiency.

Specifically, according to the wavelength conversion element 40 of the present embodiment, since the refractive index of the binder 432 is higher than the refractive index of the phosphor particle 431, most of the fluorescence Y generated inside the phosphor particle 431 is transmitted through the interface between the phosphor particle 431 and the binder 432 to enter the binder 432. Subsequently, since the fluorescence Y proceeds while being confined mainly inside the binder 432, the amount of the fluorescence Y confined inside the phosphor particle 431 significantly decreases compared to the related art. Therefore, an amount of absorption of the fluorescence Y inside the phosphor particles 431 decreases, and thus, the heat generation decreases. Thus, it is possible for the wavelength conversion element 40 to suppress the deterioration of the wavelength conversion efficiency.

The first light source device 100 according to the present embodiment is equipped with the wavelength conversion element 40 described above, and is therefore capable obtaining the high-intensity output light.

The projector 1 according to the present embodiment is equipped with the first light source device 100 described above, and can therefore be made as a high luminous flux projector.

It should be noted that the scope of the invention is not limited to the embodiments described above, but a variety of modifications can be provided thereto within the scope or the spirit of the invention.

For example, in the embodiment described above, there is cited the example in which the light source device (the first light source device 100) is provided with the wavelength conversion device including the wavelength conversion element and the motor, but it is also possible to adopt a configuration in which the light source device is not provided with the motor instead of the configuration of the example. In other words, the light source device can have a configuration which is provided with a stationary wavelength conversion element. Further, it is also possible to use a light emitting diode (LED) for emitting the blue excitation light as the excitation light source instead of the semiconductor laser for emitting the blue excitation light.

Besides the above, the numbers, the shapes, the materials, the arrangement, and so on of the constituents constituting the wavelength conversion element and the light source device can arbitrarily be modified. Further, although in the embodiments described above, there is illustrated the projector provided with the three light modulation devices, the invention can also be applied to a projector for displaying a color image using a single light modulation device. Further, the light modulation device is not limited to the liquid crystal panel described above, but a digital mirror device, for example, can also be used.

Besides the above, the shapes, the numbers, the arrangement, the materials, and so on of the variety of constituents of the projector are not limited to those of the embodiments described above, but can arbitrarily be modified.

Further, although in the embodiments described above, there is described the example of installing the light source device according to the invention in the projector, this is not a limitation. The light source device according to the invention can also be applied to lighting equipment, a headlight of a vehicle, and so on.

The entire disclosure of Japanese Patent Application No. 2018-051616, filed on Mar. 19, 2018 is expressly incorporated by reference herein.

What is claimed is:

1. A wavelength conversion element comprising:
a wavelength conversion layer including a plurality of phosphor particles made of an yttrium aluminum garnet type phosphor material including cerium as a activator agent, and a binder made of glass adapted to hold the plurality of phosphor particles,
wherein a refractive index of the binder is higher than a refractive index of the phosphor particles.

2. The wavelength conversion element according to claim 1, wherein a difference between the refractive index of the binder and the refractive index of the phosphor particles is 0.1 or more.

3. A light source device comprising:
an excitation light source adapted to emit excitation light; and
the wavelength conversion element according to claim 1.

4. A light source device comprising:
an excitation light source adapted to emit excitation light; and
the wavelength conversion element according to claim 2.

5. A projector comprising:
the light source device according to claim 3;
a light modulation device adapted to modulate light from the light source device in accordance with image information to thereby form image light; and
a projection optical device adapted to project the image light.

6. A projector comprising:
the light source device according to claim 4;
a light modulation device adapted to modulate light from the light source device in accordance with image information to thereby form image light; and
a projection optical device adapted to project the image light.
